(19) United States
(12) Patent Application Publication
(10) Pub. No.: US 2012/0166232 A1
(43) Pub. Date: Jun. 28, 2012

(54) Customer managed restaurant information system

(76) Inventor: Seth L. Neubardt, Mamaronack, NY (US)

(21) Appl. No.: 13/374,912

(22) Filed: Jan. 23, 2012

Related U.S. Application Data
(63) Continuation-in-part of application No. 12/454,259, filed on May 14, 2009, now abandoned.
(60) Provisional application No. 61/127,564, filed on May 14, 2008.

(51) Int. Cl. G06Q 50/12; G06Q 30/02; G06Q 10/02; G06Q 20/20

(52) U.S. Cl. 705/5; 705/18; 705/7.32

(57) ABSTRACT

A restaurant information system includes a point-of-sale (POS) device constructed and arranged for identifying a customer at a restaurant, an amount owed for food or other items purchased at the restaurant, a financial services provider, and a restaurant customer service of which the customer is a member. A network server is associated with the restaurant customer service, and is configured to access a personal customer file created by the customer. The POS device is configured to prompt and receive a customer entry including a review or other comments concerning the restaurant, and to address the customer entry to the network server for writing in the customer's personal file. The network server may also be configured to compile a searchable database reflecting customer entries made in a number of different customer files.

### CROSS REFERENCE TO RELATED APPLICATIONS

This application is a continuation-in-part of my co-pending U.S. patent application Ser. No. 12/454,259 filed May 14, 2009, which claims priority under 35 U.S.C. Section 119(e) of U.S. Provisional Patent Application No. 61/127,564 filed May 14, 2008.

### BACKGROUND OF THE INVENTION

1. Field of the Invention

The present invention relates generally to information systems and networks, and particularly to a system for disseminating information concerning restaurants among existing and potential customers.

2. Discussion of the Known Art

Systems have been disclosed for the purpose of allowing restaurant proprietors to obtain and manage responses to surveys and other sensitive customer-related data. Such systems often entice customers by offering them rewards if they respond to survey questions presented on a point-of-sale (POS) device when paying their tab. See, e.g., U.S. Pat. Application Pub. 2005/0043996 (Feb. 24, 2005) disclosing a system that collects and stores responses to a post dining survey which the customer enters when paying his or her check. The publication also states that the customer may log into a special web portal that provides a list of restaurants based on a set of preferences, but does not explain how or by whom the list or the preferences are compiled.

U.S. Pat. Application Pub. 2007/0214052 (Sep. 13, 2007) discloses a “consumer driven” system for hospitality applications, using telecommunication technology integration. The system is described as allowing customers to obtain restaurant-related information including blogs, and to make reservations at their “old” restaurant with seating and food selections. The publication does not detail how the system is actually constructed in order to carry out the mentioned functionality, however. See also, U.S. Pat. No. 7,281,652 (Oct. 16, 2007), describing a point-of-sale system having a customer information entry component for providing customer input to a database, wherein the database is supported by a financial service provider that implements a customer's payment at the point-of-sale; and U.S. Pat. Application Pub. 2002/0107747 (Aug. 8, 2002) which relates to a system that enables customers to find and select restaurants.

U.S. Pat. Application Pub. 2002/0107717 describes a system for conducting consumer evaluations at a POS device including a credit card reader at a restaurant. The POS device connects through a network with a payment gateway and bank transaction servers to implement an authorized transfer of funds. The gateway also acts as a survey router that transmits survey questions originating from a survey processing server to a screen at the POS device, and routes corresponding answers back to the survey processing server.

Further, U.S. Pat. No. 7,310,350 (Dec. 18, 2007) relates a system for allowing mobile device users to participate in an online survey community. A web server is configured to produce a movie guide based on opinion data obtained from a community of mobile users. Like the system described in the above '717 Publication, however, the system of the '350 patent does not allow a user to create a personal file into which he or she can enter a comment or other information that the user can elect to share with other system users.

### SUMMARY OF THE INVENTION

According to the invention, a customer managed restaurant information system includes a point-of-sale (POS) device constructed and arranged for identifying a customer at a restaurant, a monetary amount owed by the customer for food or other items purchased by the customer at the restaurant, an associated financial services provider, and a restaurant customer service of which the customer is a member. A first network server is associated with the financial services provider, and a second network server is associated with the restaurant customer service. The second network server is configured to access a personal customer file created by the customer. The POS device is configured to prompt and to receive a customer entry including a review or other comments concerning the restaurant, and to address the customer entry to the second network server for writing in the personal customer file.

For a better understanding of the invention, reference is made to the following description taken in conjunction with the accompanying drawing and the appended claims.

### BRIEF DESCRIPTION OF THE DRAWING

In the drawing:

FIG. 1 is a block diagram of a first embodiment of a customer managed restaurant system according to the invention;

FIG. 2 is a block diagram of a second embodiment of a customer managed restaurant system according to the invention;

FIG. 3 is a flow diagram portraying the transfer of financial data and customer review information in the embodiment of FIG. 1, according to the invention;

FIG. 4 is a flow diagram portraying the transfer of financial data and customer review information in the embodiment of FIG. 2, according to the invention;

FIG. 5 is a flow diagram of the transfer of financial data and customer review information with a customer's smartphone or other wireless device in the embodiment of FIG. 1, according to the invention;

FIG. 6 is a flow diagram of the transfer of financial data and customer review information with a customer's smartphone or other wireless device in the embodiment of FIG. 2, according to the invention;

FIG. 7 is a diagram illustrating communications links defined among a restaurant customer, a restaurant customer service network and a local restaurant owner network, according to the invention;

FIG. 8 is a flow chart showing steps performed by one embodiment of the inventive system from a restaurant point of sale (POS) perspective; and

FIG. 9 illustrates various components that can form a restaurant customer service network server in FIGS. 1 and 2.

### DETAILED DESCRIPTION OF THE INVENTION

The inventive system allows a restaurant patron or customer to create a personal file that is accessible only by the customer and others specifically designated by the customer, and to access the file and enter rating or other information concerning a restaurant when paying their check via a point-of-sale (POS) or other financial transaction device at the restaurant. In addition, if a customer contemplates returning to a certain restaurant for which they previously entered comments in their file, they can first access their file and review the comments before returning or calling the restaurant for a reservation.

In one embodiment, individual customer files are administered by an on-line or Internet-accessible restaurant customer service that may be identified by a domain name such as, for example, “MyCheckPlease.com”. A number of restaurant patrons may therefore become members of the service and elect to share their individual files with other service members and, if desired, with selected restaurant proprietors as well.

The POS device may include, for example, a magnetic stripe card reader that is constructed and arranged in a known manner for reading a patron's credit or debit card, and for completing a financial transaction by linking with a financial services provider associated with the card. The POS device may also be hard wired conventionally to a public switched telephone network (PSTN), or constructed in a known manner to operate wirelessly through a network access point provided at the restaurant premises.

In accordance with the invention, the POS device is also configured to access a personal file that has previously been created by the patron once the transaction is approved, for example, by (i) linking the patron to the mentioned restaurant customer service, (ii) prompting the patron to enter rating or other information concerning the restaurant, and (iii) inquiring whether or not any of the information entered by the patron may be shared with other members of the service and/or with the restaurant proprietor.

The POS device may be constructed and arranged to operate in a conventional manner insofar as the device recognizes a given restaurant customer either from a swipe of the customer's charge card, and/or from a personal identification number (PIN) entered by the customer. Once a positive identification is made, the POS device processes the transaction using, for example, one of two protocols.

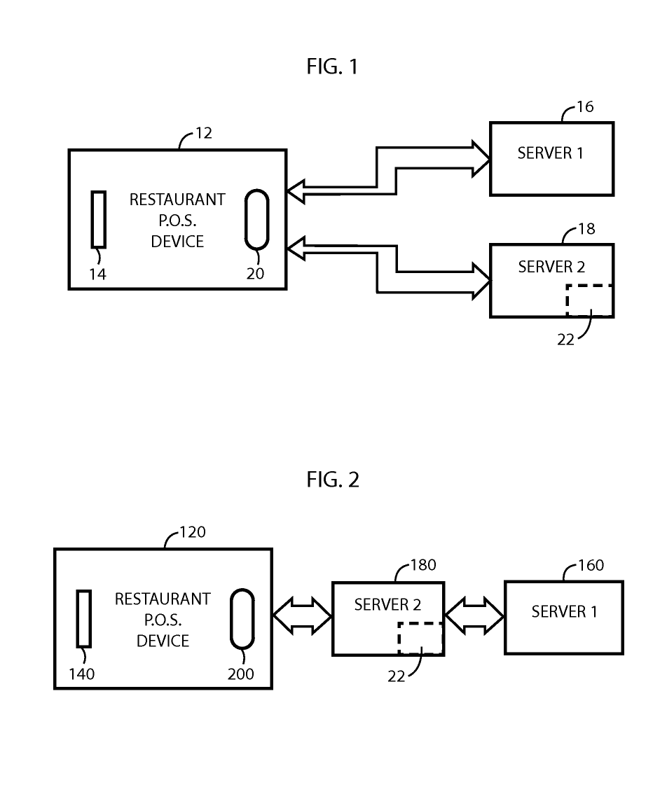

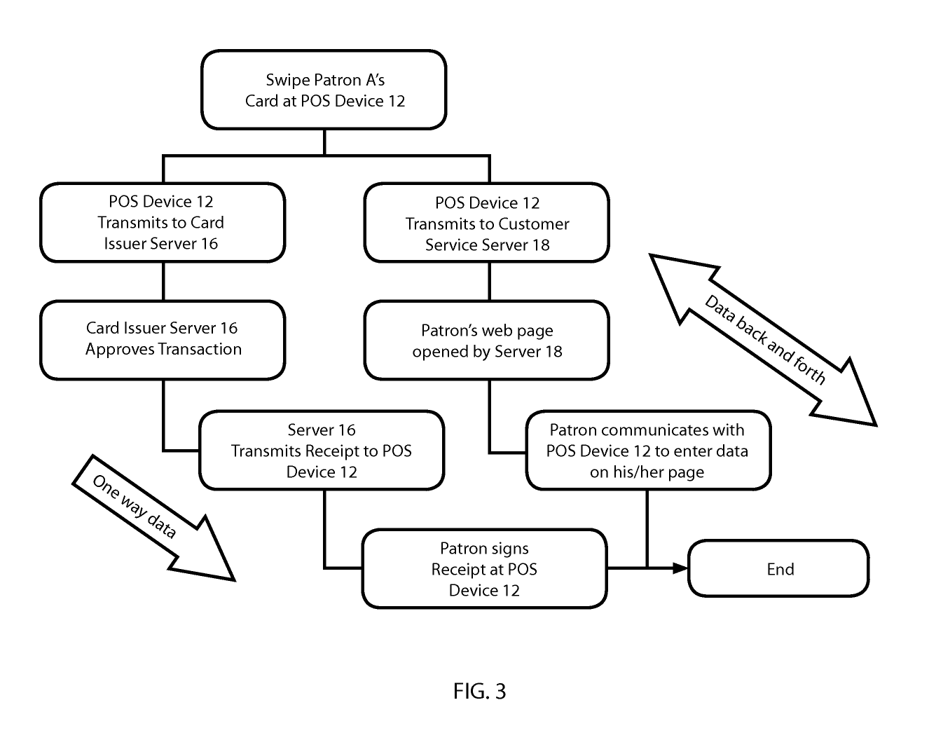

FIGS. 1 and 3 represent Example One below. In Example One, the POS device addresses a first message containing only the corresponding transaction data to a customer's financial services provider, and a second message containing only the customer's restaurant rating information is addressed to and entered into the customer's personal file maintained by the restaurant customer service.

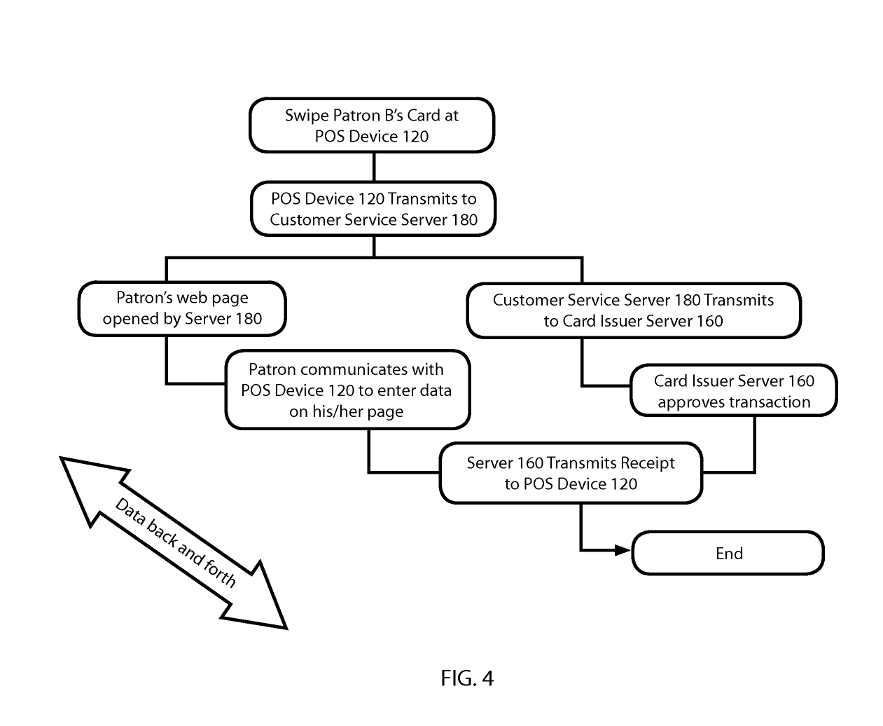

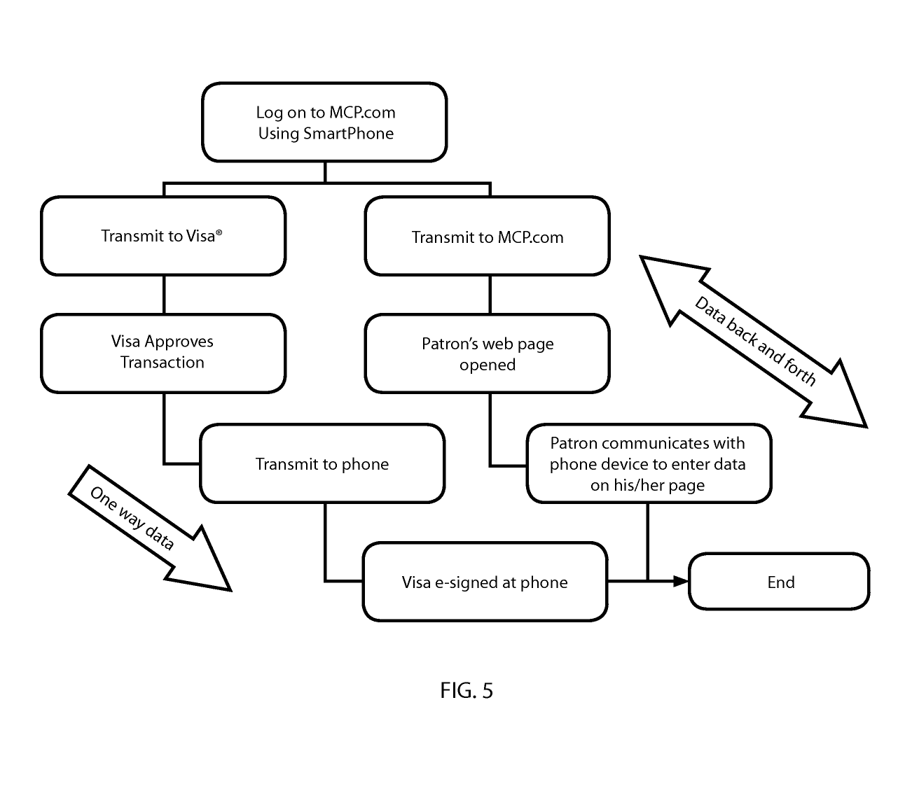

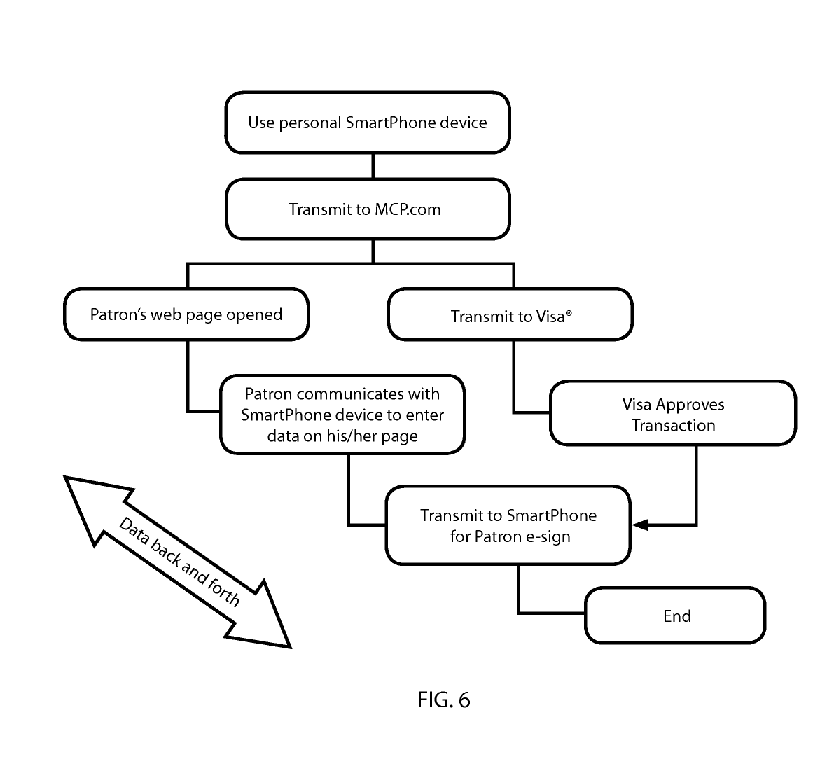

FIGS. 2 and 4 represent Example Two below. In Example Two, the transaction data and the rating information are combined in one message that is addressed to a server maintained by the restaurant customer service which, in turn, forwards the transaction data to a customer's financial services provider and reports back to the POS device. The POS device then accesses the customer's personal file and prompts the customer to add restaurant specific information or data in his or her file at that time. Alternatively, in lieu of a dedicated POS device, either protocol may be carried out by a customer's own wireless cell phone if, for example, the phone is a so-called currently available “smart” phone capable of being programmed and configured accordingly. See FIGS. 5 and 6.

### EXAMPLE ONE (FIGS. 1 AND 3)

1. Customer A is presented with a restaurant check, and the restaurant cashier swipes customer A's credit card through a POS device 12 that has been configured according to the invention.

2. The POS device 12 recognizes the card, the amount owed is entered via an input keypad 14, and the device 12 addresses the corresponding financial transaction data (customer A's identity, amount charged, etc.) via a secure link to a server 16 maintained and/or operated by the credit card provider.

3. Once the transaction is approved, the server 16 generates a receipt for customer A's signature, and sends an acknowledgment message to the POS device 12.

4. Upon receipt of the acknowledgment message, the POS device 12 addresses another server 18 maintained and/or operated by the restaurant customer service. Customer A's personal file is identified by way of, e.g., his or her name and card number as were entered in the POS device 12, and access to customer A's file is provided by the server 18. A display 20 associated with the POS device 12 then prompts customer A to enter a review or other comments concerning the restaurant into his or her file by way of the keypad 14 on the POS device 12.

### EXAMPLE TWO (FIGS. 2 AND 4)

1. Customer B is presented with a restaurant check, and the restaurant cashier swipes customer B's credit card through a POS device 120 that has been configured according to the invention.

2. The POS device 120 recognizes the card, the amount owed is entered via an input keyboard 140, and the device 120 addresses the corresponding financial transaction data (customer B's identity, amount charged, etc.) via a secure link to a server 180 maintained and/or operated by the restaurant customer service which, in turn, forwards the financial transaction data via a secure link to another server 160 maintained and/or operated by the credit card provider.

3. Once the transaction is approved, server 160 sends an acknowledgment message and a receipt for customer B's signature to the restaurant customer service server 180 which, in turn, forwards the receipt to the POS device 120.

4. Upon receipt of the acknowledgment message, the restaurant customer service server 180 also identifies customer B's personal file by way of, e.g., his or her name and credit card number, and access to customer B's file is also provided via the server 180. A display 200 associated with the POS device 120 then prompts customer B to add a review or other comments concerning the restaurant into his or her file by using the keypad 200 on the POS device 120.

In either Example One or Example Two, restaurant customers are afforded an opportunity to use a POS transaction device not only to pay for their meal purchase, but also to enter a review or other comments into their personal files to reflect their purchasing experience.

When members of the restaurant customer service elect to share information entered in their files based on their personal experiences with other service members, a database 22 reflecting combined member ratings for a number of restaurants can be compiled by the customer service server 18 or 180 using known database applications. The database 22 can also be configured in a known manner to be searchable by one or more subjects including food category, geographic location, price and the like, and made accessible exclusively to members of the service for their own use and benefit.

For members having smart phones or other wireless devices that provide Internet connectivity and are capable of being programmed by downloading desired applications (“apps”) on-line, the inventive system will allow a member who arrives at an unfamiliar destination to locate one or more restaurants whose menus and prices satisfy the member's needs. For example, upon arriving in Boston, a qualified member can log onto the customer service and enter a “Search for Restaurant” command. The member is then presented with a list of personal preferences from which he or she can select food type(s), food quality, quality of service, seating availability for breakfast, lunch or dinner; prices and the like. The member's location in Boston is then entered by the member or, if the member's smart phone or wireless device is GPS enabled, the location is determined and transmitted seamlessly by the device to the address of the restaurant customer service host server 18 or 180 in FIG. 1 or 2. The host server is then programmed and configured to compare the member's location and selected preferences with corresponding information from the member compiled database, and/or from other sources including restaurants affiliated with the service.

The host server then provides the traveling member with search results in which, for example, the top ten restaurants in or near Boston matching the member's preferences are ordered, together with an address and telephone number for each restaurant. If the member's wireless device is GPS enabled, a map of Boston can also be displayed on the device display with a marker superimposed at each restaurant location, and a numeral associated with the marker representing a ranking of the restaurant with respect to the member's preferences.

Once the member chooses a restaurant that best suits him or her, the inventive system can be configured in a known manner to provide the member with an option of having a reservation request transmitted to the restaurant for immediate acknowledgment. If desired, the option can apply to only those restaurants that are affiliated with or approved by the customer service. The member can also be prompted to enter one or more alternate restaurants in the event the first reservation choice is not obtained or confirmed.

As disclosed herein, the inventive system allows a restaurant patron to enter and store a personal review of their dining experience at the conclusion of their meal using either a wired or a wireless POS device provided at the restaurant, or the patron's own smart phone or wireless communications device when running a corresponding application. FIGS. 5 and 6 illustrate the use of a smart phone or other personal wireless communications device (e.g., a touch pad or tablet), according to the invention.

In the example of FIG. 5, upon acquiring Internet connectivity for his or her smart phone at a given restaurant by way of, e.g., a Wi-Fi access point (AP) at the restaurant or a wireless cellular network, a member of the restaurant customer service logs onto the customer service website (e.g., “MCP.com”) and opens their personal page or file after making a secure user identification. The member then enters their own rating or other information concerning the restaurant to be stored for their own future reference and, optionally, for sharing with other service members, the proprietor of the restaurant, and/or other restaurant owners who may also subscribe to the service.

If the member's smart phone or device is programmed in a known manner with one or more corresponding applications (which, for example, are made available for download to members by the customer service and/or their charge card providers), the member can (a) transmit an amount currently owed on their food bill using their smart phone to the charge card provider for approval, (b) receive an approval in the form of a payment authorization to the restaurant, (c) add any desired gratuity, and (d) electronically “sign” and transmit the payment authorization upon which the program routine ends.

In the example of FIG. 6, the member acquires Internet connectivity for their smart phone or device at a given restaurant by way of an access point that is part of a local area network operated by the restaurant. The member logs onto the customer service website and opens their personal page or file as in FIG. 5. The member then enters their rating or other information concerning the restaurant for future reference and, optionally, for sharing with other service members, the proprietor of the restaurant, and/or other restaurant owners who may also subscribe to the service.

If the member's smart phone or other communications device and the restaurant network are so programmed in a known manner, the restaurant network server can (a) transmit an amount owed by the member to the member's charge card provider for approval, either directly or through the customer service server as indicated in FIG. 6, (b) receive an approval in the form of a payment authorization to the restaurant to be signed by the member, and (c) transmit the authorization to the member's smart phone or device. The member can then add a gratuity if desired, electronically “sign” the payment authorization, and transmit the authorization upon which the program routine ends.

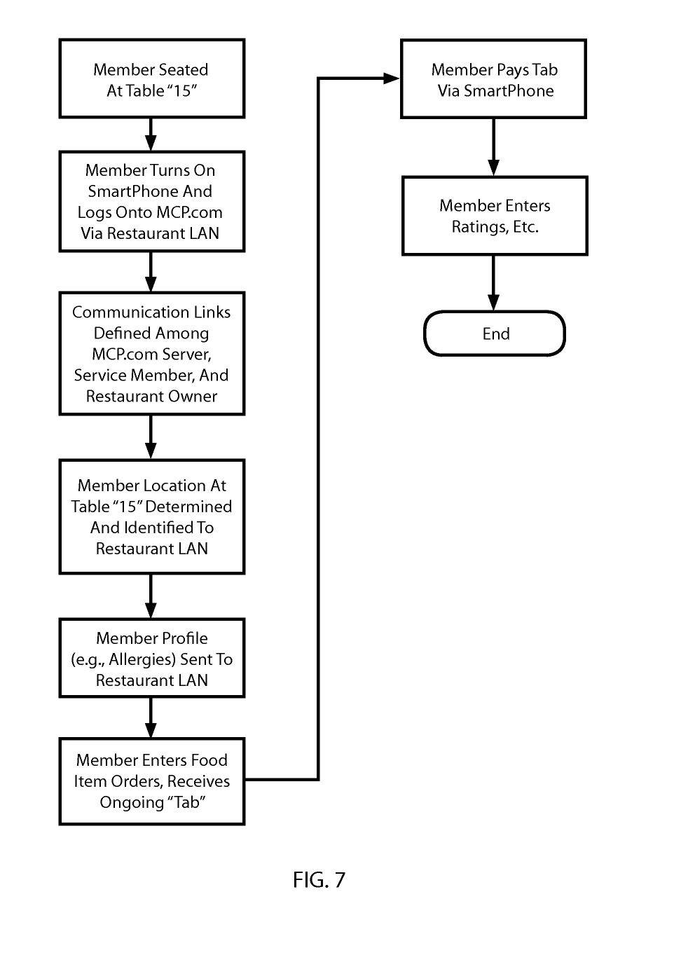

If the member's smart phone or other communications device is GPS enabled, or if the restaurant network has several access points, the member's physical location (e.g., Table Number) in a participating restaurant can be determined in a known manner and forwarded to the customer service server. Text or other types of communication links between the member, the customer service, and the restaurant kitchen or chef can then be defined using established protocols. See FIG. 7. The chef can then receive an alert directly from the customer service warning that according to a profile set up by the member who is currently sitting at, e.g., Table 15, the member has a peanut allergy, or other potentially dangerous food sensitivity.

The above communication links also allow the member's food order to be entered by the member item by item in real-time using their smart phone or other wireless device, and for current amounts owed by the member to be transmitted from the restaurant network to the device periodically, e.g., every three minutes. Accordingly, the member can, for example, press a “pay” button on their device at any time and leave the restaurant shortly thereafter upon authorization of payment, all without a need for any verbal communication with a waiter or cashier. Such communication links also allow the member to accumulate and save a “dining log” in their personal file, showing food items ordered at each restaurant visit, and the amount charged for each item at the time of the visit.

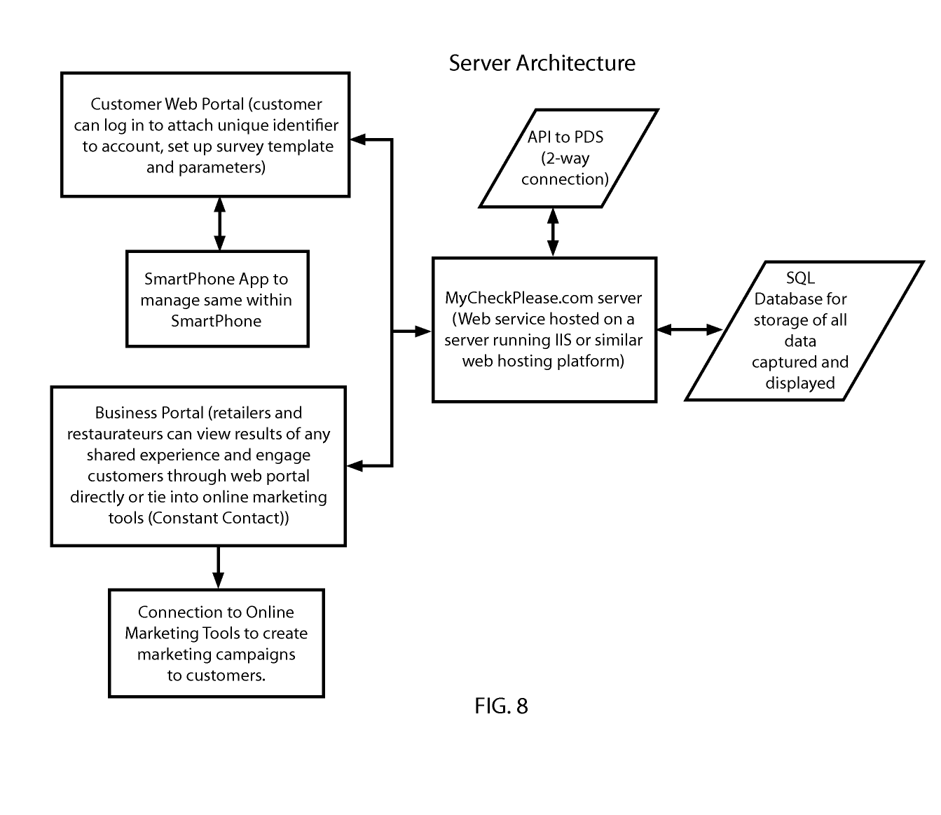

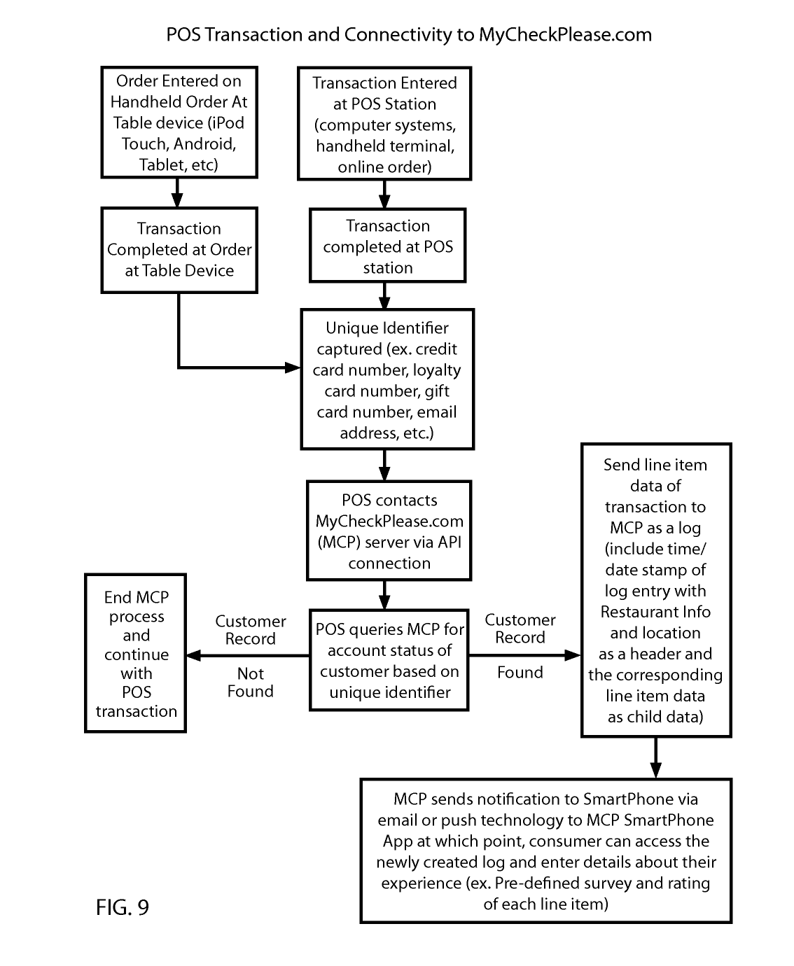

FIG. 8 is a flow chart illustrating steps carried out by one embodiment of inventive system from a restaurant point of sale (POS) perspective. FIG. 9 illustrates various components that can form the restaurant customer service server 18 or 180 in FIGS. 1 and 2.

The Customer Web Portal in the server architecture of FIG. 9 can include a setup area that allows members to create a new account, tie in their unique identifier, create custom templates for use in their ratings, and choose which ratings may be shared with a restaurant business and which remain anonymous. Members may also be allowed an option of connecting to their social networks for “blasting” their reviews to fellow network members.

As mentioned, members can also to pull up restaurant logs which they created or which are created automatically by the restaurants' POS stations at the end of each transaction. Members can also edit their stored reviews line by line or on an overall performance basis, and the templates for the logs and the reviews may be defined in the setup area. A separate Business Portal shown in FIG. 9 is associated with the server 18 or 180 to allow participating restaurant owners to connect with known online marketing tools such as, e.g., “Constant Contact” or similar e-mail marketing systems.

While the foregoing represents preferred embodiments of the invention, it will be understood by those skilled in the art that various modifications and changes may be made without departing from the spirit and scope of the invention, and that the invention includes all such modifications and changes as are within the bounds of the following claims.

I claim:

1. A customer managed restaurant information system, comprising:
a point-of-sale (POS) device constructed and arranged for identifying a customer at a restaurant, a financial transaction including a monetary amount owed by the customer for food or other items purchased by the customer at the restaurant, an associated financial services provider, and a restaurant customer service of which the customer is a member;
a first network server associated with the financial services provider, wherein the first network server is configured to produce an acknowledgment message representing an approval of the customer's financial transaction at the restaurant, and the POS device at the restaurant is configured to receive the acknowledgment message from the first network server;
the restaurant customer service is associated with a second network server that is configured to enable a member of the service including the customer to create a corresponding personal file that is accessible only by the given member and by other members of the service designated by the given member, and the POS device at the restaurant is configured to link with the second network server;
wherein each personal file is structured to include a rating, a review, or other information entered by the given member with respect to one or more restaurants patronized by the member; and
wherein, after the acknowledgment message representing an approval of the given member's financial transaction is produced by the first network server and received by the POS device at the restaurant, the POS device is configured to prompt and to receive an entry by the given member including the rating, review or other information concerning the restaurant, and to address the entry and an identification of the member to the second network server for writing the entry in the personal file of the member.

2. A restaurant information system according to claim 1, wherein the POS device is constructed and arranged to address financial transaction data concerning the given member's purchase to the first network server.

3. The system of claim 2, wherein the first network server is configured to address the acknowledgment message representing an approval of the financial transaction data to the POS device.

4. The system of claim 3, wherein the POS device is constructed and arranged to address the entry by the given member and the identification of the member to the second network server upon receiving the acknowledgment message from the first network server.

5. A restaurant information system according to claim 1, wherein the second network server is configured to compile a database corresponding to entries in a number of personal files created by members of the restaurant customer service.

6. The system of claim 5, wherein the database reflects combined member ratings for a number of restaurants, and is configured to be searchable by at least one of food category, geographic location, and price.

7. The system of claim 6, wherein the second network server is configured to allow access to the database exclusively by members of the restaurant customer service and by restaurant owners designated by the members.

8. A restaurant information system according to claim 1, wherein the second network server is constructed and arranged to be accessible by members of the restaurant customer service via the Internet.

9. A restaurant information system according to claim 1, wherein the POS device comprises a smart phone or other personal wireless communications device.

10. A restaurant information system according to claim 1, wherein the second network server is constructed and arranged to search for a certain number of restaurants in the vicinity of a given member's location, and to rank the restaurants according to attributes defined by the member.

11. A restaurant information system according to claim 10, wherein the second network server is configured to transmit a reservation request to a selected restaurant in the vicinity of the given member.

12. A restaurant information system according to claim 11, wherein the second network server is configured to transmit reservation requests only to restaurants that are affiliated with or approved by the restaurant customer service.
